(19) United States
(12) Patent Application Publication
(10) Pub. No.: US 2021/0213671 A1
(43) Pub. Date: Jul. 15, 2021

(54) PROCESS AND DEVICE FOR INSTALLATION OF A SCREEN PROTECTOR ON A SMARTPHONE, TABLET OR RELATED ACCESSORIES

(71) Applicants: Schezir KNOLL, Dubai (AE); Simon LINDSEY, Dubai (AE)

(72) Inventor: Schezir KNOLL, Dubai (AE)

(73) Assignee: Simon LINDSEY, Dubai (AE)

(21) Appl. No.: 17/149,367

(22) Filed: Jan. 14, 2021

Related U.S. Application Data
(60) Provisional application No. 62/960,753, filed on Jan. 14, 2020.

(51) Int. Cl. B29C 63/00; B29C 63/02

(52) U.S. Cl. CPC B29C 63/0004; B29L 2031/3437; B29C 2063/0008; B29C 63/02

(57) ABSTRACT

An apparatus for applying screen protection to electronic gadgets is disclosed wherein a quick locking mechanism secures the electronic gadget in a fixed place with a plurality of paddings provided on both sides of the phone. A slider is provided to adjust to different sizes of the phone in order to quickly fit any available device and a cavity allows for back cameras or any portion of the phone protruding to sink in and allow the phone to always be at level for application of the screen protection. The cavity in a base plate of the apparatus is exchangeable to fit for any phone model with different protruding cameras and portions. A process is also disclosed wherein the phone is secured to the apparatus by the lock lever and release mechanism, a transfer tape is applied onto the screen protector; then backing paper is removed. A blank is aligned over the smartphone or tablet being secured to the apparatus, then the tape is swiped over to adhere to the protector and finally tape is removed.

### TECHNICAL FIELD

The present invention relates to a study of general engineering and particularly to the study of protecting electronic gadgets from wear and scratches. The present invention specifically relates to an apparatus and a process of applying screen protection or protectors to smartphones, tablets and the like.

### BACKGROUND OF THE INVENTION

An electronic gadget or device in the today's technological era has as much as importance to the human beings as the other functional/tangible things. The electronic device such as a smart phone or a tablet today does almost every task to the—person necessary for his physical and intellectual needs. The protection or care for the said smartphones or tablet becomes a fundamental need for an individual. A smartphone or tablet screen protector is a supplemental layer of material designed to accurately adhere to a device's screen and prevent scratches and other damages which may otherwise require screen repair or replacement. These protectors typically ensure no loss in screen clarity and are available for consumer purchase in various materials such as tempered glass, polyethylene terephthalate, and thermoplastic polyurethane.

The industry is typically categorized as Pre-Cut and On-Demand Screen protectors. The Pre-Cut screen protectors are designed to fit a specific device model whereas on demand requires the material to be cut to fit the device model at the time of retail purchase. The Pre-Cut screen protectors are commonly installed by the consumer whereas on demand is a technician based installation completed at the point of retail purchase.

The On-Demand installation is commonly a process requiring a liquid substance (also referred to as ‘gel’) to be applied to the device screen to enable a technician to align the protector material to the dimensions of the screen. The use of gel in this process often creates imperfections like scratches, lines or impurities in the final finish of the screen protector material. Additionally, the wet install process requires time for the screen protector material to harden and cure which can exceed 24 hours. Therein, the on demand process would greatly benefit from an installation which requires no gel to be used or in other words, a dry installation.

Presently there is no specific apparatus available to secure a Smartphone or tablet device in place to facilitate the installation of an on demand screen protector to the screen surface of that device in a dry adhesion state. Various techniques are employed for applying screen protectors and they all seem to be affecting the accuracy. In today's electronic world almost all the screen protectors for the smartphone are manually put over the smartphone screen and it leads to small air holes which then become almost impossible to extract them out. A number of the other ways were also operated.

In a relevant art JP'5990197 which discloses a touch screen protector for a handheld electronic device having a front face with a touch screen portion and an outer periphery, front surface, a Side 2, the outer peripheral portion corresponding to the front portion of the electronic device, and a plastic film having a transparent window size corresponding to the touch-screen portion. Said transparent window provided on the back surface of the plastic film along the outer periphery of the plastic film while encirclement, the said plastic film. The protector of the electronic device is formed so as to form a sealed space between the transparent window of the plastic film, the spacer, and the touch screen portion of the electronic device. Freely attach exposed adhesive is removably attached to the outer peripheral portion of the front face and includes an exposed adhesive, the protector for mounting on the front face of the electronic device, with a sufficient adhesion adhesive residues to allow removal of the protector without leaving on the electronic device. In operation when the transparent window is pressed against the touch screen portion of the electronic device, being applied to the back surface of the plastic film in a state facing the touch screen, having fine particles to prevent interference patterns or sticking due to static electricity, wherein the transparent window may be pressed on the touch screen portion for operation of the electronic device, direct contact of a finger with the touch screen portion of the user is prevented. However it can be stated that it is firstly too risky to push down the screen and there is always a risk of wears and scratches on the surface of the smartphone or tablet screen.

Another relevant art EP'1621968 states a liquid crystal display device protection structure for electronic equipment having an equipment cabinet made of a plastic material in which a liquid crystal display device is accommodated, the equipment cabinet formed with a viewing window so as to be faced with a display screen of the liquid crystal display device, comprising a reinforcing frame made of a material having a mechanical strength higher than that of the plastic material used for the equipment cabinet, and having a frame shape matched to a periphery of the viewing window, the reinforcing frame being integrally fixed to the equipment cabinet so as to be matched to the periphery of the viewing window. A display screen protection cover which is mounted to the reinforcing frame and covers the viewing window, wherein the reinforcing frame comprises a front plate that is developed so as to be matched to the display screen of the liquid crystal display device, and has an opening for exposing the display screen. The display screen protection cover is mounted to the reinforcing frame by using a double-sided adhesive tape; and in that the reinforcing frame has a box-like shape and comprises; side plates that are developed from an outer edge of the front plate to a direction along thickness of the front plate so as to surround an entire periphery of the liquid crystal display device. In this case, generally conventional phones having small or non-touch screens are covered by screen protectors. Furthermore, the phone to be covered by the screen protector has to dis-assemble first and then after applying screen guard, it is then assembled again and there screen protector needs more curing time to be dried.

The solution to this industrial problem is to, firstly design and manufacture an apparatus to secure the smartphone or tablet device in preparation for the installation of an On-Demand screen protector and secondly to eliminate the gel based on demand wet installation process and replace it with a dry installation process which renders a high quality finish and requires no curing time.

### BRIEF SUMMARY OF THE INVENTION

The present invention discloses a QUIX TECH apparatus and a process for applying a screen protector onto a surface of a phone or smartphone or tablet. The screen protector applied onto the screen of the smartphone protects the smartphone from scratches and wears. The present invention provides an apparatus and a method for easily applying a screen protector with minimal or almost no scratches.

A preferred embodiment of the invention states a QUIX TECH apparatus for applying screen protection to electronic gadgets. The apparatus comprising a quick locking mechanism which secures an electronic gadget or phone or tablet in a fixed place; a plurality of paddings provided on both sides of the phone; a slider which is able to adjust to different sizes of the phone in order to quickly fit any available device; a cavity which allows for back cameras or any portion of the phone protruding to sink in and allow the phone to always be at level for application of the screen protection. The cavity in a base plate of the apparatus is exchangeable to fit for any phone model with different protruding cameras and portions and a suction feet is provided to fix the phone on a flat surface.

In one of the most preferred embodiment of the invention a process of applying a screen protector to an electronic gadget or phone or tablet is disclosed. The process comprising steps of: placing a phone or tablet into a QUIXTECH apparatus with screen surface of the phone facing outwards and the phone's back positioned on a lower base of the apparatus; retaining any protrusion on the phone rear casing usually associated with the phone's camera and lens; pushing top edge of the phone into a designated cushioned buffer; pushing sliding buffer forward to create firm contact with a bottom edge of the phone, wherein the sliding buffer is locked using a quick lock and release lever positioned on one side of the QUIXTECH apparatus; placing a precut or cut on demand screen protector with its retainer layer intact on an adjacent flat surface of the phone or tablet; placing a transfer tape above said screen protector and introducing pressure onto the transfer tape whereby said tape is affixed by pressure adhesion to the surface of said screen protector; and lifting the transfer tape subsequently by allowing the screen protector to be released from its retainer layer thereby exposing the adhesive side of the screen protector.

The process further states that the screen protector is now attached to a larger surface area of the transfer tape free from its retainer layer and is easily moved to said apparatus proximity without any need to touch or to come into contact with the exposed adhesive side of the screen protector; affixing one end of the transfer tape to the QUIX TECH apparatus using only designated surface and adhesive properties of the transfer tape; lowering the transfer tape to allow top edge of the screen protector's adhesive to contact surface of the phone; applying pressure on the top surface of the transfer tape for final adhesion of the screen protector to the phone's screen, using a small squeegee and run along the entire surface of the phone's screen in one smooth motion; peeling away the transfer tape from the surface of the screen protector which is being firmly adhered to the phone's screen; and releasing the phone by the quick lock and release lever.

The invention further states that after the adhesion of the transfer tape, the outline of the screen protector is clearly visible beneath the transparent transfer tape and can be realigned several times above the smartphone or tablet or phone which is to be protected without touching the adhesive side of the screen protector.

Another embodiment of the invention states when a phone is secured to the apparatus by the lock lever and release mechanism, a transfer tape is applied onto the screen protector; then backing paper is removed. The blank is aligned over the smartphone or tablet being secured to the apparatus, then to adhere the screen protector on to the phone the tape is swiped over and finally tape is removed or peeled off.

The QUIX TECH apparatus securely retains a smartphone or tablet device without any scratch. The apparatus at the base provides a necessary provision or cavity for any protruded area of the phone. The protruded surface can be a back camera, lens, or any other part of the phone casing or body at the back.

The invention further discloses an apparatus to specifically clamp and secure a mobile Smartphone and or tablet device to facilitate the installation of a TPU, PET, GLASS or other commonly used material to protect the LCD, OLED, AMOLED, Super AMOLED, TFT, IPS device screen (also commonly referred to as a ‘screen protector’). Furthermore, the apparatus allows for the installation of the screen protector to be completed with a dry adhesive application as opposed to a process more commonly used where a gel chemical is applied to the screen of the smartphone or tablet device to activate adhesion (also commonly referred to as a ‘wet install’). The disadvantages of a wet install being the curing time of the screen protector which can exceed 24 hours. The apparatus also allows the use of a simple adhesive transfer tape (also referred to as a ‘release liner’) to lift the screen protector from its retainer and to subsequently place, position and align the screen protector to the device's screen and thus renders the requirement of multi-layer cap sheet redundant. The apparatus function in summary, facilitates a fast and precision aligned dry installation of a smartphone or tablet screen protector with no curing time required.

### BRIEF DESCRIPTION OF DRAWINGS

The embodiments herein will be better understood from the following detailed description with reference to the drawings, in which:

FIG. 1 illustrates a two dimensional view of a QUIXTECH apparatus displaying different geometric views of said apparatus.

FIG. 2 and FIG. 3 illustrate an isometric three dimensional views of the QUIXTECH apparatus.

FIG. 4 illustrates a bottom view of said apparatus displaying stands or legs or paddings.

FIG. 5 illustrates a top view of the QUIX TECH apparatus.

FIG. 6 and FIG. 7 illustrate a left side and a right side view of the apparatus.

FIG. 8 illustrates a bottom side view of the apparatus displaying all the stands or legs on which the apparatus stands and is fixed.

FIG. 9 illustrates an upside down view of the apparatus displaying a quick lock and release lever positioned on one side of the QUIXTECH apparatus.

FIG. 10 to FIG. 15 illustrates a process of applying a screen protector onto the smartphone or tablet.

### DETAILED DESCRIPTION OF THE INVENTION

The embodiments herein and the various features and advantageous details thereof are explained more fully with reference to the non-limiting embodiments that are illustrated in the following detailed description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims. The terms like can be, shall be, could be, and other related terms herein disclosed in the foregoing and later parts of the specification in any means do not limit or alter the scope of the present invention. The terms are provided just for the mere understanding of the main invention and its embodiments.

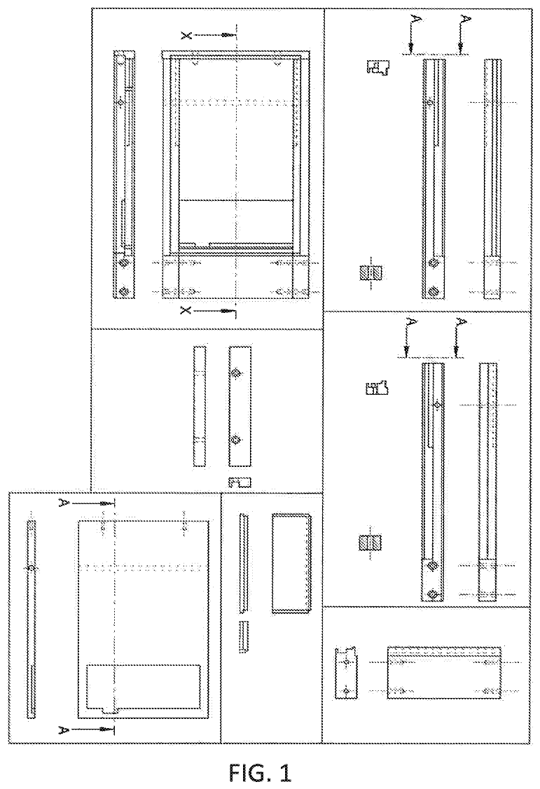

From FIG. 1 of the present invention which is displaying different geometrical representations of the apparatus. The size of the apparatus displayed in the geometric arrangements varies depending upon the requirements of the particular user. However for every apparatus there is provided a flexibility to fit any kind of smartphone, tablet and the like electronic gadgets.

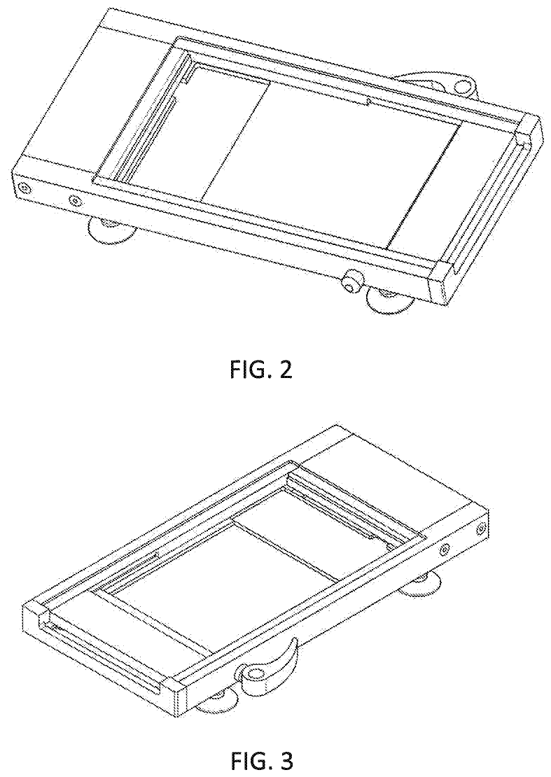

FIG. 2 and FIG. 3 of the present invention illustrate a three dimensional geometry of the apparatus. From the upper part of the apparatus a space is provided wherein a smartphone is placed with its upper side or screen side facing upwards. There is provided a quick lock and release lever mechanism and by the application of said mechanism the smartphone is secured to the surface of the apparatus.

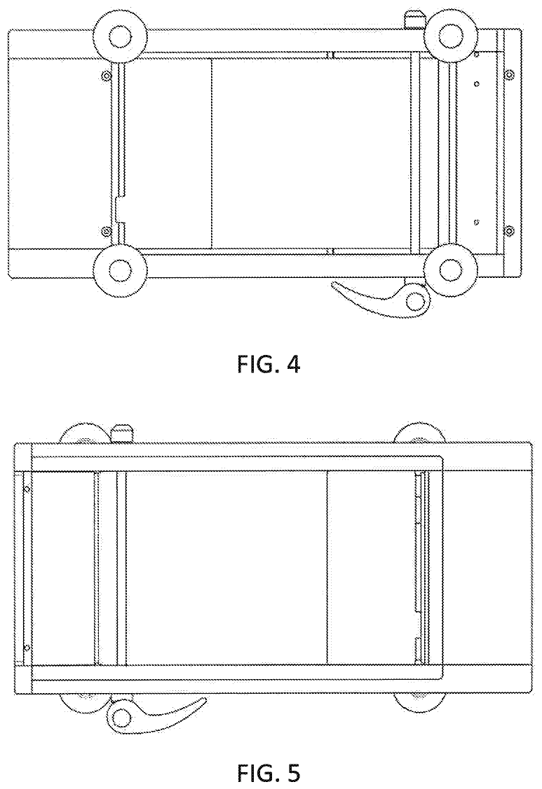

FIG. 4 and FIG. 5 illustrate the bottom and the top view of the apparatus. The bottom view displays stands or legs onto which the QUIX TECH apparatus is fixed to some ground, so that during the processing of applying a screen protector over the phone, the apparatus may not move or slide. The quick lock and release lever is provided therein. A cavity is provided which allows for back cameras or any portion of the phone protruding to sink in and allow the phone to always be at level for application of the screen protection. The cavity in a base plate of the apparatus is exchangeable to fit for any phone model with different protruding cameras and portions. A plurality of paddings is provided on both ends to protect the phone from damage but at the same time allows enough grip to hold the phone in place.

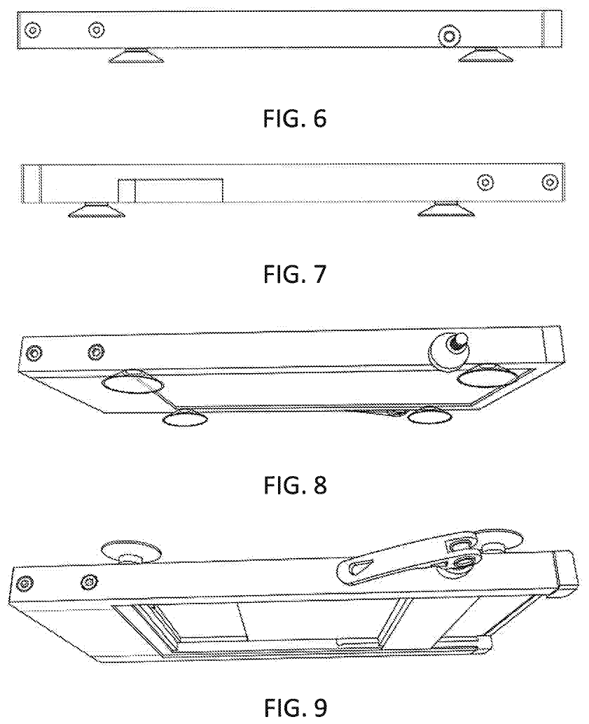

FIG. 6 and FIG. 7 illustrate the left side and the right side view of the apparatus. A slider is provided which is able to adjust to different sizes of the phone in order to quickly fit any available device.

FIG. 8 illustrates a bottom side view of the apparatus displaying all the stands or legs on which the apparatus stands and is fixed. The paddings or legs or stands are provided to fix or secure the apparatus to a fixed ground so that the apparatus as a whole does not slide over while applying protector onto the phone.

FIG. 9 shows an upside down view of the apparatus displaying a quick lock and release lever positioned on one side of the QUIXTECH apparatus. The slider as stated above after making a space for the phone is locked or secured by the quick lock and release lever in order to secure the phone at one position.

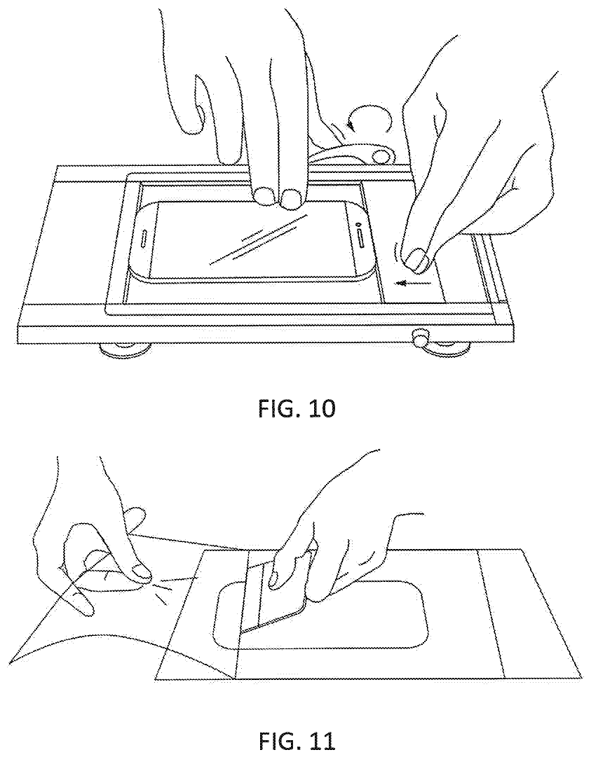

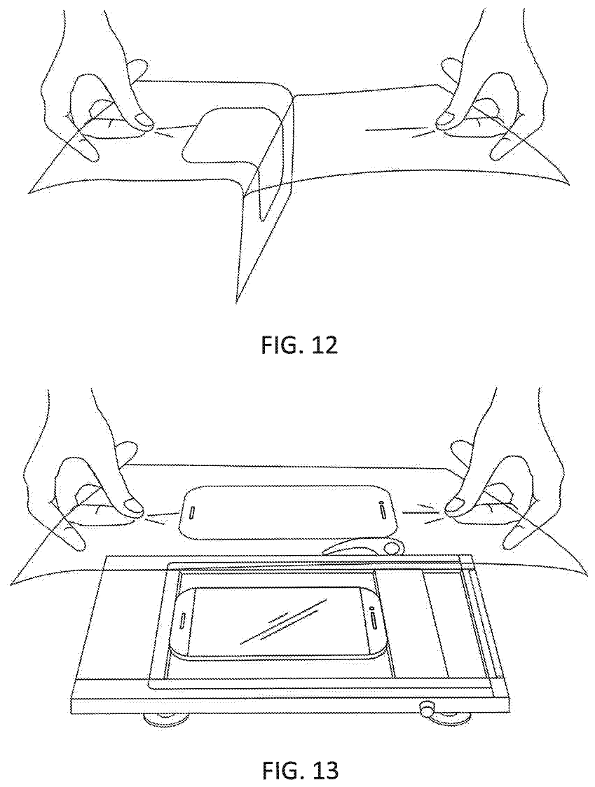

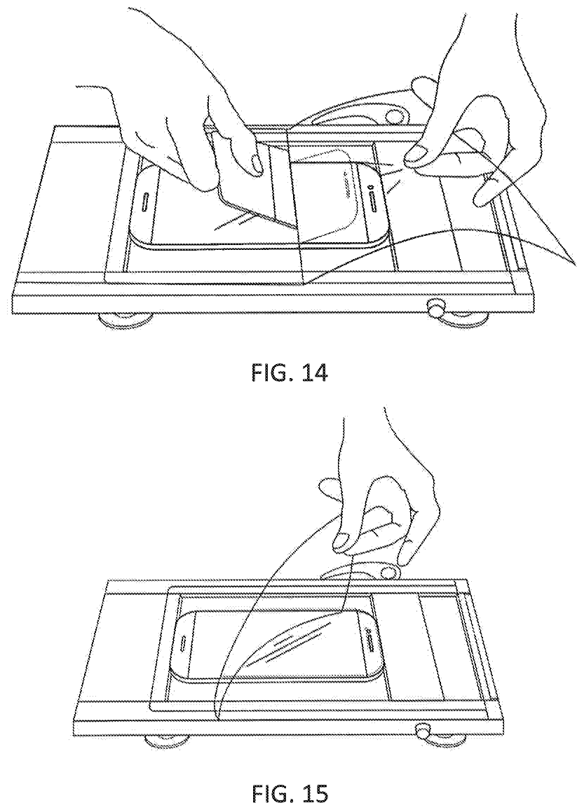

FIG. 10 to FIG. 15 illustrates a process of applying a screen protector onto a smartphone or tablet. FIG. 10 displays a first step of securing the phone to the QUIX TECH apparatus by the slider and secured by the quick lock and release lever. When the phone is placed over the surface of the apparatus and the slider is moved towards the edge or end of the phone and then the lever is rotated to fix the slider at the specific position corresponding to the shape or space occupied by the phone. FIG. 11 illustrates a second step of applying a transfer tape onto the screen protector which is to be applied onto the phone screen or display. FIG. 12 illustrates a third step of the process wherein a backing paper from the screen protector is removed. FIG. 13 shows a third step wherein the blank from which the backing paper is removed is aligned to the screen of the phone. FIG. 14 illustrates a fourth step of the process wherein a swipe is made over the transfer tape to adhere the screen protector onto the phone. FIG. 15 illustrates a final step of the process wherein the transfer tape is removed from the screen protector.

Furthermore, a process applying a screen protector to an electronic gadget or phone. The process comprising steps placing a phone or tablet into a QUIX TECH apparatus with screen surface of the phone facing outwards and the phone's back positioned on a lower base of the apparatus, retaining any protrusion on the phone rear casing usually associated with the phone's camera and lens, pushing top edge of the phone into a designated cushioned buffer. After, pushing sliding buffer forward to create firm contact with a bottom edge of the phone, wherein the sliding buffer is locked using a quick lock and release lever positioned on one side of the QUIX TECH apparatus, placing a precut or cut on demand screen protector with its retainer layer intact on an adjacent flat surface of the phone or tablet, placing a transfer tape above said screen protector and introducing pressure onto the transfer tape whereby said tape is affixed by pressure adhesion to the surface of said screen protector. Then, lifting the transfer tape subsequently by allowing the screen protector to be released from its retainer layer thereby exposing the adhesive side of the screen protector. The screen protector is now attached to a larger surface area of the transfer tape free from its retainer layer and is easily moved to the said apparatus proximity without any need to touch or to come into contact with the exposed adhesive side of the screen protector.

The process further states that affixing one end of the transfer tape to the QUIX TECH apparatus using only designated surface and adhesive properties of the transfer tape; lowering the transfer tape to allow top edge of the screen protector's adhesive to contact surface of the phone. A slight pressure is applied on the top surface of the transfer tape for final adhesion of the screen protector to the phone's screen, using a small squeegee and run along the entire surface of the phone's screen in one smooth motion. The transfer tape is then peeled off from the surface of the screen protector which is being firmly adhered to the phone's screen and the phone is released by the said quick lock and lever mechanism.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms mentioned.

1. An apparatus for applying screen protection to electronic gadgets, the apparatus comprising:
a quick locking mechanism which secures an electronic gadget or phone or tablet in a fixed place, wherein said mechanism is a quick lock and release lever;
a plurality of paddings provided on both sides of the phone;
a slider which is able to adjust to different sizes of the phone in order to quickly fit any available device;
a cavity which allows for back cameras or any portion of the phone protruding to sink in and allow the phone to always be at level for application of the screen protection;
wherein the cavity in a base plate of the apparatus is exchangeable to fit for any phone model with different protruding cameras and portions;
wherein a suction feet is provided to fix the phone on a flat surface.

2. A process of applying a screen protector to an electronic gadget or phone, the process comprising steps of:
placing a phone or tablet into an apparatus with screen surface of the phone facing outwards and the phone's back positioned on a lower base of the apparatus;
retaining any protrusion on the phone rear casing usually associated with the phone's camera and lens;
pushing top edge of the phone into a designated cushioned buffer;
pushing sliding buffer forward to create firm contact with a bottom edge of the phone, wherein the sliding buffer is locked using a quick lock and release lever positioned on one side of the apparatus;
placing a precut or cut on demand screen protector with its retainer layer intact on an adjacent flat surface of the phone or tablet;
placing a transfer tape above said screen protector and introducing pressure onto the transfer tape whereby said tape is affixed by pressure adhesion to the surface of said screen protector;
lifting the transfer tape subsequently by allowing the screen protector to be released from its retainer layer thereby exposing the adhesive side of the screen protector;
wherein the screen protector is now attached to a larger surface area of the transfer tape free from its retainer layer and is easily moved to said apparatus proximity without any need to touch or to come into contact with the exposed adhesive side of the screen protector;
affixing one end of the transfer tape to the apparatus using only designated surface and adhesive properties of the transfer tape;
lowering the transfer tape to allow top edge of the screen protector's adhesive to contact surface of the phone;
applying pressure on the top surface of the transfer tape for final adhesion of the screen protector to the phone's screen, using a small squeegee and run along the entire surface of the phone's screen in one smooth motion;
peeling away the transfer tape from the surface of the screen protector which is being firmly adhered to the phone's screen; and
releasing the phone by the quick lock and release lever.
